(19) United States
(12) Patent Application Publication
(10) Pub. No.: US 2013/0066913 A1
(43) Pub. Date: Mar. 14, 2013

(54) DATASET RATING AND COMPARISON

(71) Applicants: Elisa Flasko, Duvall, WA (US); Robert M. Fries, Kirkland, WA (US); Maxim Uritsky, Redmond, WA (US); Lukasz Gwozdz, Issaquah, WA (US)

(72) Inventors: Elisa Flasko, Duvall, WA (US); Robert M. Fries, Kirkland, WA (US); Maxim Uritsky, Redmond, WA (US); Lukasz Gwozdz, Issaquah, WA (US)

(73) Assignee: MICROSOFT CORPORATION, Redmond, WA (US)

(21) Appl. No.: 13/232,810

(22) Filed: Sep. 14, 2011

(51) Int. Cl. G06F 17/30

(52) U.S. Cl. 707/776; 707/E17.143

(57) ABSTRACT

Providing information about two or more datasets. The method includes accessing metadata for two or more datasets. The method further includes displaying a comparison of the two or more datasets based on metadata for the two or more datasets.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Computing systems are often useful for obtaining, transforming, and presenting data. There are several ways to obtain data. For example, a user can manually generate data. Alternatively, systems and equipment can automatically generate data, such as log data, or historical performance data. Further still, data may be purchased or obtained from others who provide data. For example, a data consumer can obtain data from a data publisher. In yet a more sophisticated example, data can be obtained through data brokers. For example, the Windows Azure Marketplace, available from Microsoft Corporation of Redmond Wash., is a data clearing house where data publishers and data consumers can connect so that data consumers can obtain data from data publishers. Examples of data available from data publishers may include, but is certainly not limited to, financial data, business listing data, telephone and email data, legal data, mapping data, demographic data, employment data, stock data, etc.

Currently when purchasing or otherwise obtaining data from content publishers, customers are limited in their ability to compare one set of data to another set of data to determine if one set of data should be purchased (or otherwise obtained) over another set of data.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment herein includes a method practiced in a computing environment. The method includes acts for providing information about one or more datasets. The method includes accessing metadata for two or more datasets. The method further includes displaying a comparison of the two or more datasets based on metadata for the two or more datasets.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a graphical user interface showing dataset information;

FIG. 2 illustrates a graphical user interface showing comparisons of dataset information; and

FIG. 3 illustrates a method of providing dataset information

### DETAILED DESCRIPTION

Embodiments may include functionality for viewing data about past availability and/or performance trends of a service offering a dataset and/or the quality of datasets. Further, systems may facilitate comparing this data against other service offerings and/or datasets to determine if an offering meets their performance requirements when searching, viewing and making a purchasing decision for datasets.

Embodiments may include functionality to allow customers to, at a glance, determine the expected performance of a particular service offering and/or quality of a dataset, while comparing service offerings and/or datasets and making a purchasing decision. Embodiments may allow customers to easily filter, sort and compare service offerings based on one or more expected performance ratings, past actual performance measures, and/or data quality measurements and to easily see the current status of one or more service offerings.

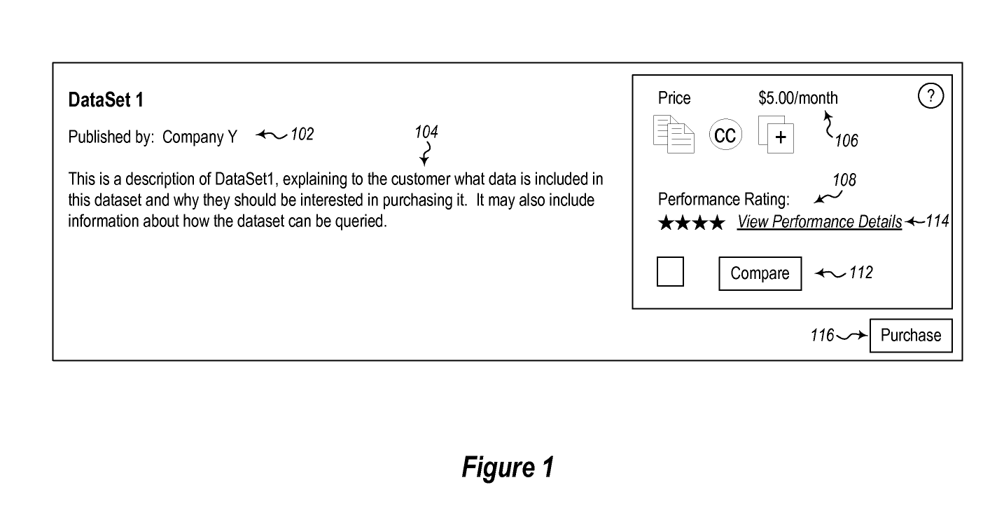

Referring now to FIG. 1, an example is illustrated. FIG. 1 illustrates a graphical user interface 100 showing information about a dataset. The information includes information 102 about the company publishing the dataset and information 104 describing the dataset. The graphical user interface 100 may also include information 106 about the cost of obtaining a dataset.

The graphical user interface may further include information 108 regarding a performance rating of a dataset. The performance rating may allow a customer to quickly and easily determine, in some embodiments at a glance, how a particular service offering rates. This may be done for example, on the basis of past performance, such as past response time, throughput, etc.

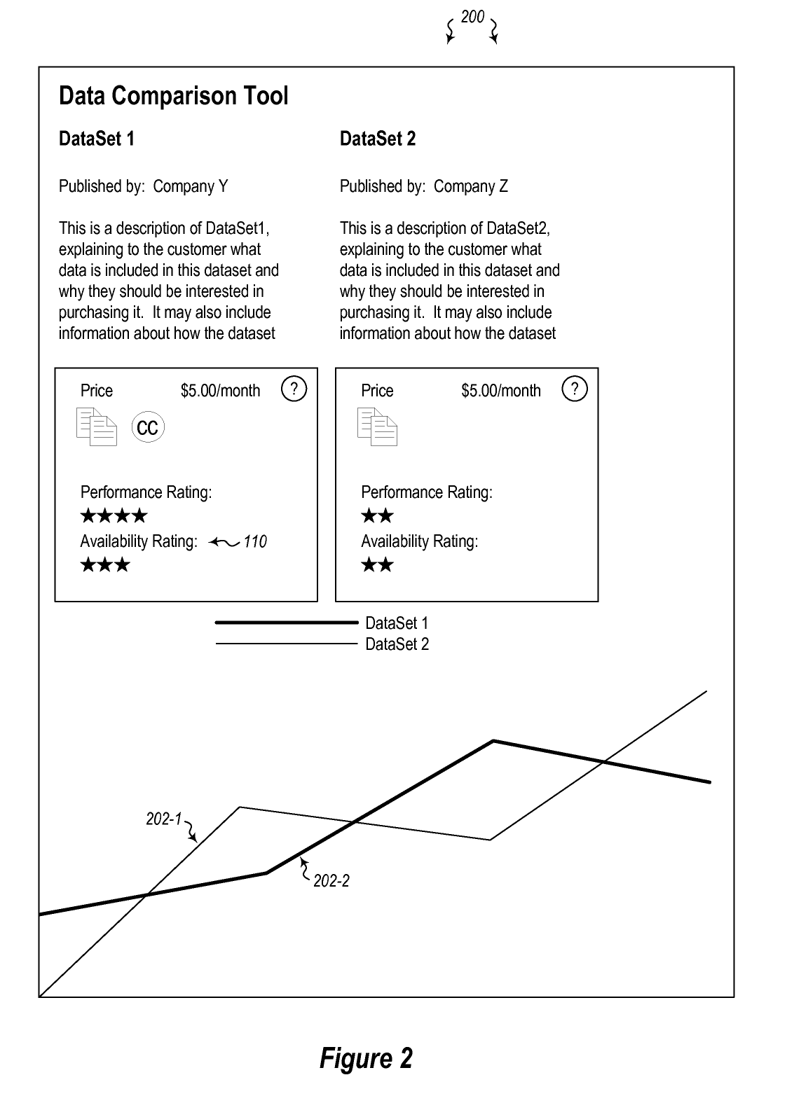

Although not shown in FIG. 1 (but shown and discussed in conjunction with FIG. 2), embodiments may include information 110 regarding the availability of a dataset.

Although also not shown in FIG. 1, some embodiments may include information regarding social sentiment on specific datasets and data providers. Rating calculations can be based on the social sentiment information. For example, embodiments may be implemented where social sentiment ratings calculations or overall rating calculations may factor in what people feel about the provider and/or the usefulness of a specific data. Such data may be available and collected from various social networks, such as Facebook, Twitter, Linked-In, on blogs, and other social media channels.

The graphical user interface 100 may further include functionality for performing a performance comparison. For example, in the example illustrated in FIG. 1, a check box and compare interface 112 may be used by a user to select a dataset for comparison with another dataset. When a customer chooses two or more service offerings and selects to compare them side by side, a side by side comparison view (such as that shown in FIG. 2) includes the ability for the customer to compare the performance rating, and to compare other information. For example, FIG. 2 illustrates a display where functionality is included to overlay past actual performance graphs 202-1 and 202-2 of two service offerings being compared.

Some embodiments may include the ability for a customer to easily sort and filter based on both guaranteed performance and past actual performance when browsing service offerings.

When browsing the Marketplace looking for a service offering that meets specific requirements, customers see not only the description and basic details defining what a service offering contains, how it can be used, and how much it will cost, but also the service offerings.

As noted above, the user interface 100 includes information 108 about a performance rating. In some embodiments, the information 108 may be associated with user interface elements, such as a link 114 that allows a user to learn more about the service offering's history of performance. For example, in one embodiment, hovering over the performance rating link 114 will provide a larger view of a summary graph of actual past performance over the lifetime of the offering. Clicking on the link 114 will allow the user to view detailed analysis and visual representation of a service offering's performance over its lifetime. Similar functionality may be available for availability data and/or quality data.

In some embodiments, while browsing service offerings, customers are able to easily sort and filter the offerings based on both guaranteed performance and past actual performance.

When comparing service offerings, customers can select two or more service offerings that they would like to view side by side. FIG. 2 illustrates an example of a user interface 200 where a side by side comparison of two different service offerings are illustrated. In some embodiments, the side by side comparison view may include the ability for a customer to compare one or more of performance ratings, guaranteed performance, and or data quality. For example, as illustrated in FIG. 2, the user interface 200 includes a performance rating and an availability rating for each service offering. These can be compared in a side by side fashion. Embodiments may include the ability to compare past actual performance. For example, FIG. 2 illustrates an example where past actual performance graphs of the two service offerings are overlaid on top of each other.

While FIG. 2 only illustrates comparisons of two datasets, it should be appreciated that two or more datasets may be compared together. For example, in some embodiments, embodiments may overlay all datasets in a given thematic category or from the same provider on the same graph and facilitate a user being able to find the best and worst ones at a single glance.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

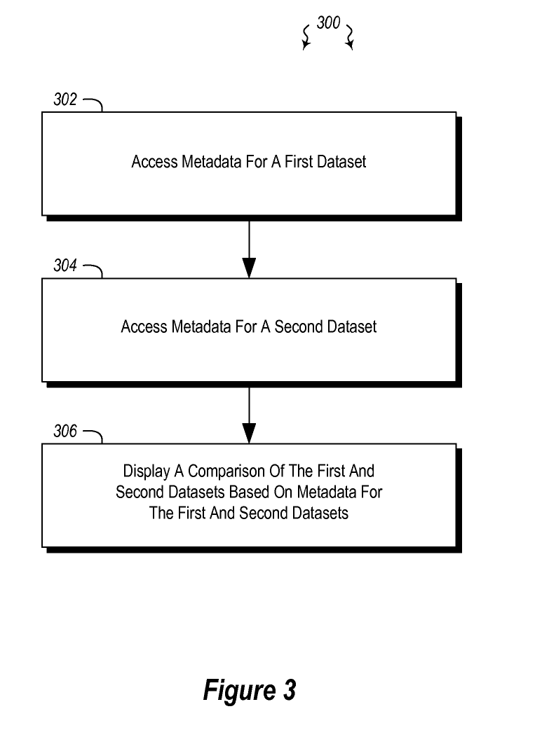

Referring now to FIG. 3, a method 300 is illustrated. The method 300 may be practiced in a computing environment and includes acts for providing one or more datasets. The method 300 includes accessing metadata for a first dataset (act 302). The metadata for a first dataset may be, for example, one or more of performance metadata, availability metadata, or quality metadata.

Performance metadata may include one or more of a number of different metrics, including past performance and/or guaranteed performance. Such performance metadata may describe characteristics like throughput or response time. In particular, performance metadata may describe throughput in terms of a rate at which data from a dataset can be delivered to users. Performance metadata may define response time as a measure of the amount of time it takes to provide data from a dataset once a request for the data has been received. Performance characteristics may be affected by hardware used by a data provider and/or networks between a data provider and a data consumer.

Additionally, performance characteristics may be affected by the nature of a distributed system for delivering data. For example, some systems have redundant servers located in various geographic locations. This may result in better performance for a given server. In some examples, this may result in better performance if a data consumer is physically located close to one of the redundant servers. This may affect a performance rating. Some embodiments may be able to provide data regarding performance. Additionally, some embodiments may provide performance based on a data consumers location, as performance may be better or worse depending on a data consumer's location.

The method 300 further includes accessing metadata for a second dataset (act 304). This may include actions and functionality similar to act 302 for the first dataset. It should be noted that while two datasets are shown here, this embodiment also includes when multiple datasets are accessed and compared

The method 300 further includes displaying a comparison of the first and second datasets based on metadata for the first and second datasets (act 306). For example, FIG. 2 illustrates an example where datasets are compared based on metadata about the datasets. In particular, FIG. 2 illustrates a user interface 200 comparing dataset performance ratings, availability ratings, and actual past performance graphs.

The method 300 may further include receiving a user selection of either the first dataset or the second dataset based on the comparison of the first and second datasets. For example, FIG. 1 illustrates a purchase interface 116 that allows a user to purchase a dataset.

As noted above, the metadata for the first and second datasets may include metadata defining performance, availability or quality of a dataset. In one embodiment of the method 300, the metadata includes performance data. For example, the performance data may include information about a location from where a dataset may be obtained. For example, the information may define different locals from which data from a dataset can be obtained. If a dataset has a copy located geographically closer to an end user, then that dataset may have faster performance from the perspective of the user. This information, along with user information, may be factored into a performance rating displayed to a user and/or be presented directly to the user. Presenting information directly to the user may include, for example, numerical representations, graphical representations, and the like.

In another example where the metadata may include performance data, the performance data may include information about a data delivery format. For example, the same data may be delivered in different formats, such as in simple text format, html, word processing formats, PDF formats, etc. Some formats have larger overhead than other formats and thus obtaining those formats with larger overheads may not be done as efficiently as formats with lower overheads, resulting in lower performance for the larger overhead formats. This information may be factored into a performance rating displayed to a user and/or be presented directly to the user.

In another example, the metadata may include information about availability of a dataset. For example, the availability information may include information about a percentage of time that a dataset is available. For example, a dataset may have historically not been available for certain periods of time. Time that the dataset was not available will decrease the percentage of time that a dataset is available. This can be included as part of calculating an availability rating and/or presented directly to the user.

In another example where the metadata may include availability information, the availability information may include information about an amount of time it takes to restore access to a dataset after access to a dataset has been interrupted. For example, after a dataset has become unavailable (for example, due to hardware, software or other failures) there may be a space of time that it takes to restore the dataset and make the dataset available to users again. Historical information can be collected and average, median, mean, or other measures or agglomerations of time may be used in calculating an availability rating and/or presenting availability data directly to the user.

In another example where the metadata may include availability information, the availability information may include information about a number of times that a dataset has become inaccessible. For example, as noted above, a dataset may become unavailable (for example, due to hardware, software or other failures). Information about the number of times a dataset has become available may be collected and may be used in calculating an availability rating and/or presenting availability data directly to the user.

Embodiments may be implemented where the metadata may include quality of a dataset information. In one example embodiment, the quality of a dataset information may include error metrics for a dataset. Such error metrics may include information about how many errors have historically been transmitted in a dataset. Alternatively, error metrics may define the accuracy of a dataset. For example, suppose the dataset include mapping data. An error metric may define the number of errors in street names and locations. Alternatively, the error metric may define a percentage of erroneous (or correct) data from the dataset. This information may be used in calculating a quality rating and/or presenting quality data directly to the user.

In another example where the metadata includes quality of a dataset information, the quality of a dataset information may include completeness information for a dataset. For example, information may be collected about map data completeness, zoom levels for a map, coverage data for a map, an indication of the last time a dataset was updated, etc.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In a computing environment, a method of providing information about one or more datasets, the method comprising:
accessing metadata for a first dataset, the metadata for the first dataset comprising performance data about a source of the first dataset;
accessing metadata for a second dataset, the metadata for the second dataset comprising performance data about a source of the second dataset; and
displaying a comparison of the first and second datasets based on metadata for the first and second datasets, the comparisons comprising a graphical and a textual representation comparing performance and comparing availability of the datasets.

2. The method of claim 1, further comprising receiving a user selection of either the first dataset or the second dataset based on the comparison of the first and second datasets.

3. The method of claim 1, wherein the metadata for the first and second datasets comprises at least one or more of information about performance, availability or quality of a dataset.

4. The method of claim 3, wherein the metadata comprises performance information about a dataset, and wherein the performance information comprises information about a location from where a dataset may be obtained.

5. The method of claim 3, wherein the metadata comprises performance information about a dataset, and wherein the performance information comprises information about a data delivery format of a dataset.

6. The method of claim 3, wherein the metadata comprises availability information about a dataset, and wherein the availability information comprises information about a percentage of time that a dataset is available.

7. The method of claim 3, wherein the metadata comprises availability information about a dataset, and wherein the availability information comprises information about an amount of time it takes to restore access to a dataset after access to a dataset has been interrupted.

8. The method of claim 3, wherein the metadata comprises availability data, and wherein the availability data comprises information about a number of times that a dataset has become inaccessible.

9. The method of claim 3, wherein the metadata comprises information about the quality of a dataset, and wherein the quality information comprises error metrics for a dataset.

10. The method of claim 3, wherein the metadata comprises information about the quality of a dataset, and wherein the quality information comprises completeness information for a dataset.

11. The method of claim 10, wherein the completeness information comprises one or more of map data completeness, map zoom levels, map coverage data, or information about when data was last updated data.

12. A computer program product comprising physical computer readable storage media having stored thereon computer executable instructions that when executed by one or more processors causes the following to be performed:
receiving metadata for a first dataset, the metadata for the first dataset comprising performance data about a source of the first dataset;
receiving metadata for a second dataset, the metadata for the second dataset comprising performance data about a source of the second dataset; and
displaying a comparison of the first and second datasets based on metadata for the first and second datasets, the comparisons comprising a graphical and a textual representation comparing performance and comparing availability of the datasets.

13. The computer program product of claim 12, wherein the metadata for the first and second datasets comprises at least one or more of information about performance, availability or quality of a dataset.

14. The computer program product of claim 13, wherein the metadata comprises performance information about a dataset, and wherein the performance information comprises information about a location from where a dataset may be obtained.

15. The computer program product of claim 13, wherein the metadata comprises performance information about a dataset, and wherein the performance information comprises information about a data delivery format of a dataset.

16. The computer program product of claim 13, wherein the metadata comprises availability information about a dataset, and wherein the availability information comprises information about a percentage of time that a dataset is available.

17. The computer program product of claim 13, wherein the metadata comprises availability information about a dataset, and wherein the availability information comprises information about an amount of time it takes to restore access to a dataset after access to a dataset has been interrupted.

18. The computer program product of claim 13, wherein the metadata comprises availability data, and wherein the availability data comprises information about a number of times that a dataset has become inaccessible.

19. The computer program product of claim 13, wherein the metadata comprises information about the quality of a dataset, and wherein the quality information comprises error metrics for a dataset.

20. In a computing environment, a method of providing comparison information about one or more datasets, the method comprising:
displaying in a user interface representations of a plurality of datasets, the user interface including a performance rating for each of the plurality of datasets;
receiving user input indicating that a first data set and a second data set are to be compared;
accessing metadata for the first dataset, the metadata for the first dataset comprising performance data about a source of the first dataset;
accessing metadata for the second dataset, the metadata for the second dataset comprising performance data about a source of the second dataset; and
displaying a comparison of the first and second datasets based on the metadata for the first and second datasets, the comparisons comprising a graphical and a textual representation comparing performance and comparing availability of the datasets.
